(19) United States
(12) Patent Application Publication
(10) Pub. No.: US 2010/0199861 A1
(43) Pub. Date: Aug. 12, 2010

(54) Treating Apparatus

(75) Inventor: Tomoyuki Godai, Kobe-shi (JP)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: MAYATEC CO., LTD., Kobe-shi, Hyogo (JP)

(21) Appl. No.: 12/525,057

(22) PCT Filed: Jan. 29, 2008
(86) PCT No.: PCT/JP2008/051247

§ 371 Date: Mar. 12, 2010

(30) Foreign Application Priority Data
Feb. 6, 2007 (JP) 2007-027041

(51) Int. Cl. A23B 4/06; H05B 3/02

(52) U.S. Cl. 99/483; 219/439

(57) ABSTRACT

A treating apparatus includes a container having an interior set at a predetermined temperature, a support means for supporting an object to be treated in the container such that insulation is maintained between the container and the object to be treated, and an alternating-current power applying means for applying an alternating-current voltage which is not smaller than 10V and not larger than 5 kV, through the support means, to the object to be treated such that a current which is not smaller than 1 μA and not larger than 1,000 mA flows therein, wherein oxidation of the object to be treated is suppressed by providing the above current to the object to be treated.

### TECHNICAL FIELD

The present invention relates to a treating apparatus, and more particularly, to a treating apparatus capable of applying an alternating-current power such that a weak current flows in an object to be treated.

### BACKGROUND ART

A variety of techniques for suppressing deterioration in the quality of goods (e.g. oxidation or release of water) have heretofore been developed. As a familiar example, there can be mentioned a thawing technique for frozen materials (e.g. frozen foodstuffs).

When thawing such frozen materials, it is convenient if the frozen materials can be thawed within a short period of time without causing impairment of their taste, appearance and the like. For this reason, as an example of such a thawing technique, a method has been proposed in which the temperature inside a thawing box containing frozen materials is raised by means of heated air (see patent document 1 and patent document 2 as conventional examples).
Patent document 1: Japanese Patent Application Unexamined Publication No. H08-214850
Patent document 2: Japanese Patent Application Unexamined Publication No. H07-253265

### DISCLOSURE OF THE INVENTION

### Problem to be Solved by the Invention

However, the thawing techniques described in the above conventional examples are not of a type based on a detailed analysis of the factors of deterioration of freshness at the time of thawing frozen materials and are half-baked techniques from the point of view of keeping freshness of frozen materials.

The present invention has been accomplished in view of these circumstances, and an object thereof is to provide a treating apparatus that is capable of properly suppressing deterioration in quality of an object to be treated.

### Means for Solving the Problem

In order to solve the above problem, a first treating apparatus of the present invention includes a container having an interior set at a predetermined temperature, a support means for supporting an object to be treated in the container such that insulation is maintained between the container and the object to be treated, and an alternating-current power applying means for applying an alternating-current voltage which is not smaller than 10V and not larger than 5 kV, through the support means, to the object to be treated such that a current which is not smaller than 1 μA and not larger than 1,000 mA flows therein, wherein oxidation of the object to be treated is suppressed by providing the current to the object to be treated.

Furthermore, a second treating apparatus of the present invention includes a container having an interior set at a predetermined temperature, a support means for supporting a frozen object to be treated in the container such that insulation is maintained between the container and the object to be treated, and an alternating-current power applying means for applying an alternating-current voltage which is not smaller than 10V and not larger than 5 kV, through the support means, to the object to be treated such that a current which is not smaller than 1 μA and not larger than 1,000 mA flows therein, wherein the object to be treated is thawed by providing the current to the object to be treated.

This, in the case, for example, where the alternating-current power is utilized for thawing frozen foodstuffs, allows the tissue of the frozen foodstuffs to be activated and appropriate preservation of their freshness.

In addition, a third treating apparatus of the present invention includes a container having an interior set at a predetermined temperature, a support means for supporting an object to be treated in the container such that insulation is maintained between the container and the object to be treated, and an alternating-current power applying means for applying an alternating-current voltage which is not smaller than 10V and not larger than 5 kV, through the support means, to the object to be treated such that a current which is not smaller than 1 μA and not larger than 1,000 mA flows therein, wherein freshness of the object to be treated is preserved without its freezing by providing the current to the object to be treated.

Here, an example of the above support means includes a first metallic plate disposed in the interior to place the object to be treated thereon, a current-carrying rail of metal electrically connected to the first metallic plate, and a metallic support bar for supporting the first metallic plate through a first insulating member, wherein the alternating-current voltage is applied to the current-carrying rail.

Additionally, another example of the above support means includes a second insulating member extending upright from a lower wall of the container into the interior, a second metallic plate supported on an end face of the second insulating member to place the object to be treated thereon, wherein the second metallic plate is electrically connected to the current-carrying rail through a wire.

By supporting the metallic plate on the tip end face of the second insulating member provided upright on the lower wall of the treating container, dead space in the treating space may be avoided, thereby making effective use of the space.

Furthermore, the support means may include a hook for supporting the first insulating member and the first metallic plate, and the position of the first metallic plate may be set based on the locking position of the hook to the metallic support bar.

Furthermore, the above first and second insulating members are preferably insulators.

Since each of the voltage-applying members is insulated using an insulator having superior insulating properties, appropriate insulation of these members may be maintained even if the interior of the treating container becomes an unfavorable environment for electric insulation such as a high-humidity environment with a high moisture content.

It should be noted that if the object to be treated is a foodstuff of meat or seafood, there are cases where it is preferable to set the current to a value which is not smaller than 500 μA and not larger than 800 μA.

In addition, if the object to be treated is a foodstuff of vegetable or fruit, there are cases where it is preferable to set the current to a value which is not smaller than 1 μA and smaller than 500 μA. And, there are cases where it is preferable that the current provided to the foodstuff of vegetable or fruit is substantially 100 μA.

Furthermore, frozen tuna or frozen salmon may be thawed as the object to be treated using the above treating apparatus.

This allows to properly prevent freezer burn (oxidation) of the frozen tuna or frozen salmon.

The above object, other objects, features and advantages of the present invention will become apparent from the following detailed description of the preferred embodiments with reference made to the accompanying drawings.

### Effect of the Invention

According to the present invention, a treating apparatus is obtained which enables to appropriately suppress deterioration in the quality of the objects to be treated.

### BRIEF DESCRIPTION OF DRAWINGS

FIG. 1 is a view of the interior of a power applying apparatus according to an embodiment of the present invention, as viewed in a left and right direction.

FIG. 2 is a view of the interior of a power applying apparatus according to an embodiment of the present invention, as viewed in an upper and lower direction.

### DESCRIPTION OF REFERENCE NUMERALS

10 Treating container
11 Alternating-current power generating device
12 Current-carrying rail
13b, 13c, 13d Metallic support bar
14, 15 Metallic plate
16a, 16b Wire
17 Elastic member (plate spring)
18 Hook
19, 20a, 20b Insulator
21 Frozen material (frozen object to be treated)
22, 23 Door
100 Power applying apparatus (treating apparatus)
101 Mounting unit

### BEST MODE FOR CARRYING OUT THE INVENTION

A preferred embodiment of the present invention will now be described with reference to the drawings.

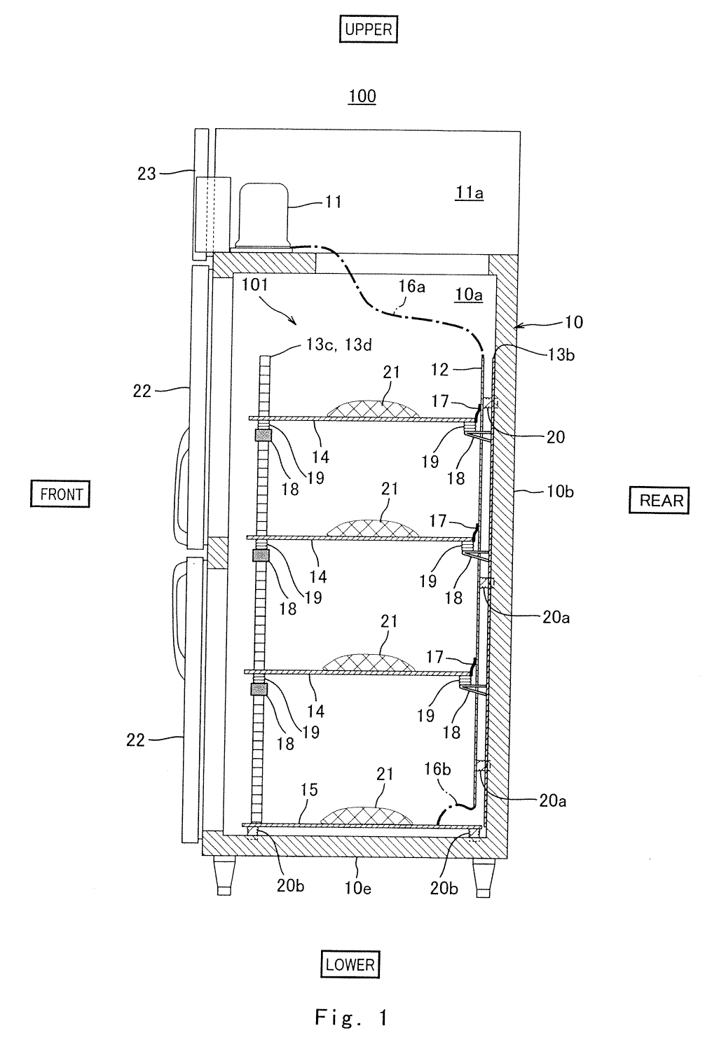

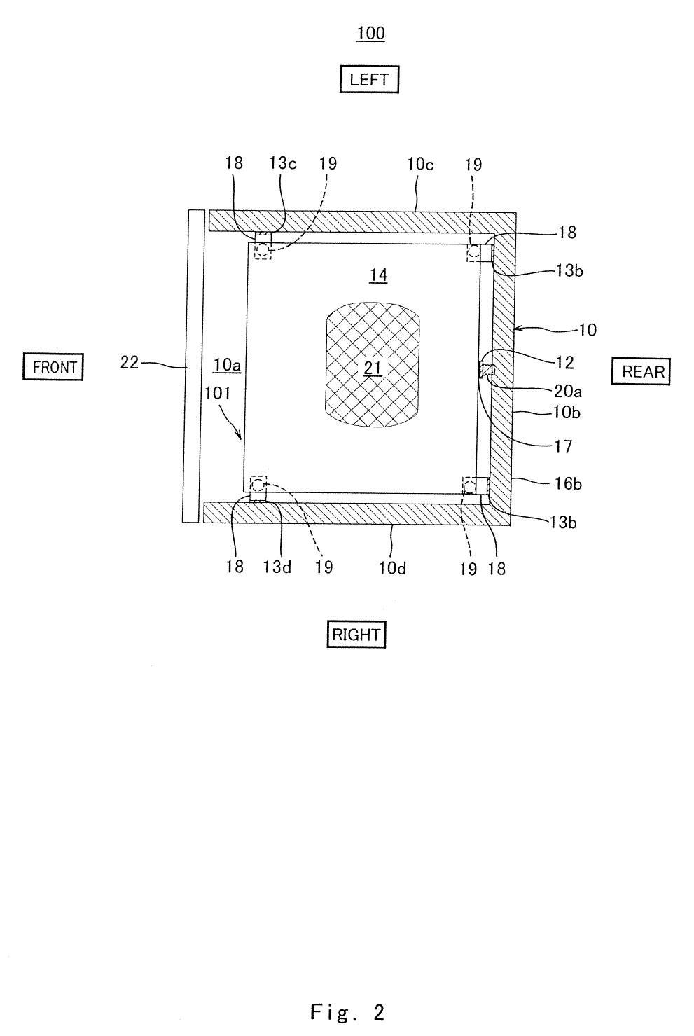

FIG. 1 is a view of the interior of a power applying apparatus (treating apparatus) according to an embodiment of the present invention, as viewed in a left and right direction, and FIG. 2 is a view of the interior of the power applying apparatus according to the embodiment of the present invention, as viewed in an upper and lower direction.

It should be noted that, with respect to FIGS. 1 and 2, for convenience of description below, the direction in which the self weight of the power applying apparatus 100 acts is referred to as the “upper and lower” direction, the door 22 side of the power applying apparatus 100 as the “front” side, the side opposite the door 22 as the “rear” side, and the direction perpendicular to the “upper and lower” direction and the “front and rear” direction as the “left and right” direction.

The power applying apparatus 100, as shown in FIGS. 1 and 2, primarily includes a treating container 10 of box shape (rectangular parallelepiped), the internal temperature of which is settable at a thawing temperature of frozen materials 21 (frozen objects to be treated), an alternating-current power generating device 11 (alternating-current power applying means) disposed inside a housing space 11a located over the treating container 10, and a mounting unit 101 disposed inside a treating space 10a of the treating container 10.

In other words, the treating container 10 has the treating space 10a (interior of the treating container 10) for thawing frozen materials 21. The housing space 11a is provided on the treating container 10, which accommodates, in addition to the above alternating-current power generating device 11, various known operation equipment (not shown) for the purpose of operating the power applying apparatus 100. Doors 22, 23 are provided to enable access to the objects contained in the treating space 10a and the housing space 11a, respectively.

It should be noted that, in the present specification, frozen materials 21 include, in addition to a solid object, liquid and gaseous objects packed in an appropriate bag (not shown) and, in short, mean various kinds of freezable foodstuffs containing water or freezable drinking water.

The mounting unit 101, as shown in FIGS. 1 and 2, includes metallic plates 14, 15 for placing a frozen material 21 thereon, a metal-made current-carrying rail 12 of rectangular shape which is electrically connected to the metallic plates 14, 15 in a manner capable of applying an alternating-current voltage thereto, and which extends in the upper and lower direction, and rod-like metallic support bars 13b, 13c, 13d which support three metallic plates 14 via insulators 19 made of ceramic (made of pottery) or made of resin.

The metallic support bars 13b, 13c, 13d include two metallic support bars 13b attached in proximity to the left and right ends of the rear side wall 10b of the treating container 10 to extend in the upper and lower direction, one metallic support bar 13c attached in proximity to the front end of the left side wall 10c of the treating container 10 to extend in the upper and lower direction, and one metallic support bar 13d attached in proximity to the front end of the right side wall 10d of the treating container 10 to extend in the upper and lower direction.

Each of these metallic support bars 13b, 13c, 13d is provided in the form of a ladder, which enables a hook 18 to be locked at an appropriate height of the metallic support bar 13b, 13c, 13d. In other words, in the present embodiment, the hooks 18 are attached to an upper, intermediate and lower step of each of the four metallic support bars 13b, 13c, 13d one by one, so that a metallic plate 14 with a frozen material 21 placed thereon is supported by the insulators 19 on the hooks 18. This allows the height (position in the upper and lower direction) of a metallic plate 14 to be adjustably set based on the locking position of the hooks 18 attached to the metallic support bars 13d, 13c, 13d (the position of plate springs 17 also needs to be changed). These metallic support bars 13b, 13c, 13d, as compared with conventional support bars made of resin, are advantageous in that they are less likely to get soiled or damaged. Furthermore, the use of insulators 19 with excellent insulation properties for supporting the metallic plates 14 is suitable in that proper insulation is maintained between the metallic plates 14 and the metallic support bars 13b, 13c, 13d even under an undesirable environment for electric insulation such as when the treating space 10a becomes a moisture-rich atmosphere.

The alternating-current power generating device 11 includes a transformer (not shown) therein, and one of a pair of secondary terminals of the transformer is electrically connected to the current-carrying rail 12 through a wire 16a, while the other (not shown) of the secondary terminals of the transformer is opened. An electrically conductive elastic member 17 (here, plate spring 17 of metal) is provided between the current-carrying rail 12 and each of the metallic plates 14. This allows an appropriate electric contact to be made between the current-carrying rail 12 and the metallic plates 14 by the biasing force of the plate springs 17, the metallic plates 14 being restricted with respect to their in-plane movement by a suitable fixing means (not shown). In this way, one of the pair of secondary terminals of the transformer is electrically connected with the metallic plates 14. And, the metallic plates 14 (frozen materials 21) and the other of the pair of secondary terminals of the transformer are insulated from each other by air.

Substantially at the center in a width direction of the rear side wall 10b of the treating container 10, three insulators 20a made of ceramic (made of pottery) or made of resin are spaced equidistant from one another along the upper and lower direction and partially embedded. These insulators 20a take the form of extending perpendicular from the rear side wall 10b into the treating space 10a, and the above current-carrying rail 12 is fixed to the tip end face of the insulators 20a. By fixing the current-carrying rail 12 with such insulators 20a having superior insulating properties, appropriate insulation can be suitably maintained between the current-carrying rail 12 and the treating container 10 (rear side wall 10b) even under an undesirable environment for electric insulation such as when the treating space 10a becomes a moisture-rich atmosphere.

Additionally, four insulators 20b made of ceramic (made of pottery) or made of resin are partially embedded in proximity to four corners of the lower wall 10e of the treating container 10. These insulators 20b take the form of extending perpendicular from the lower wall 10e into the treating space 10a, and the metallic plate 15 is supported on the tip end face of the insulators 20b.

It should be noted that the metallic plate 15 is electrically connected to the current-carrying rail 12 through a wire 16b. Consequently, as is the case with the metallic plates 14, the above alternating-current voltage is applied to the metallic plate 15 and the frozen material 21 placed on the metallic plate 15.

Thus, in the power applying apparatus 100 of the present embodiment, by supporting the metallic plate 15 on the tip end face of the insulators 20b extending upright from the lower wall 10e of the treating container 10, a dead space is avoided in the treating space 10a to make effective use of the treating space 10a. Furthermore, by using the insulators 20b, which are superior in insulating properties, for support of the metallic plate 15, proper insulation can suitably be maintained between the metallic plate 15 and the treating container 10 (lower wall 10e) even under an undesirable environment for electric insulation such as when the treating space 10a becomes a moisture-rich atmosphere.

The operation of the power applying apparatus 100 constructed as above (operation for preserving freshness of the frozen materials 21) will now be described.

First, the door 22 of the treating container 10 is opened and closed to locate the frozen material 21 on the metallic plates 14 and 15. In this instance, the temperature of the treating space 10a is set, for example, to a value which is not lower than −5° C. and not higher than +10° C.

Next, a primary voltage is applied between a pair of primary terminals of the transformer of the alternating-current power generating device 11. This primary voltage here is a sinusoidal alternating-current voltage having a commercial frequency. Then, a secondary voltage is induced between the secondary terminals of the transformer, and a load voltage, the secondary voltage obtained by subtracting the voltage drop due to a ballast resistor (not shown) and ammeter (not shown), is applied between the frozen materials 21 (accurately, metallic plates 14 and 15) and the other of the pair of secondary terminals of the transformer. Consequently, a weak load current, which corresponds to the load impedance (leak resistance and capacitance) between the frozen materials 21 and the other of the pair of secondary terminals of the transformer, flows in the frozen materials 21. A predetermined alternating-current power is thus applied from the alternating-current power generating device 11 to the current-carrying rail 12, to the metallic plates 14, 15, and to the frozen materials 21. Alternatively, the other of the secondary terminals may be electrically grounded with a high resistance element disposed between the metallic plates 14, 15 and a ground terminal, rather than allowing the other of the secondary terminals to be opened.

Here, it is preferable that the above load voltage is not smaller than 10V and not larger than 5 kV, and more preferable not smaller than 100V and not larger than 5 kV. And, it is preferable that the above load current is not smaller than 1 μA and not larger than 1,000 mA, and not smaller than 10 μA and not larger than 100 mA.

Next, the mechanism in which freshness of the frozen materials 21 is preserved by the power applying apparatus 100 of the present embodiment will be described.

Factors that cause the degradation of frozen materials 21 (deterioration in freshness) related to the thawing of the frozen materials 21 are broadly grouped as follows. Here, it should be noted that a description will be made taking a frozen foodstuff as an example of frozen material 21.

### (1) Degradation by Release of Water

If the temperature of a frozen foodstuff rises too high with thawing of the foodstuff, the cells become no longer capable of holding the water contained in the tissue. Then, breaks occur in the cell membranes, resulting in release of water (occurrence of drippings). This released water contains lots of nutrients and, as a result, accelerates the growth rate of bacteria.

### (2) Degradation by Oxidation

Fat and other ingredients in a foodstuff combine with oxygen in the air to be oxidized. Such oxidation causes the foodstuff to progress in degradation.

Accordingly, the power applying apparatus 100 of the present embodiment prevents the above degradation of a foodstuff in the following manner.

First, thawing is performed at a predetermined temperature range (e.g. not lower than −5° C. and not higher than +10° C.), so as to properly suppress cell tissue destruction. Furthermore, the power applying apparatus 100 activates the cells in a foodstuff by the application of high-voltage energy through electrostatic induction, and therefore prevents a reduction in the energy to be consumed in the foodstuff and acts to suppress the release of water. On the other hand, it is conceivable that the frozen foodstuff is smoothly thawed by the effect of activation of the cells, even at the above predetermined temperature range.

Furthermore, it is conceivable that if a foodstuff is given a high-voltage energy through electrostatic induction and electrically charged (i.e., if a foodstuff is given a weak current), the ionic balance becomes unstable, causing suppression of the combination of oxygen in the air and the foodstuff. It should be noted that although the detailed mechanism in which oxidation of foodstuffs is suppressed is not revealed, it has already been verified that, if an alternating current is supplied to foodstuffs under the conditions of a predetermined voltage (not smaller than 10V and not larger than 5 kV) and current (not smaller than 1 μA and not larger than 1,000 mA), oxidation of the foodstuffs is suppressed.

As described above, according to the power applying apparatus 100 of the present embodiment, an alternating-current power can be supplied to an object to be treated under the conditions of a predetermined voltage (not smaller than 10V and not larger than 5 kV) and current (not smaller than 1 μA and not larger than 1,000 mA). This, in the case where the alternating-current power is utilized, for example, for thawing a frozen foodstuff, allows the tissue of the frozen foodstuff to be activated, thereby properly preserving its freshness.

Furthermore, since in the power applying apparatus 100 of the present embodiment insulators 19, 20a, 20b having superior insulating properties are used to insulate each voltage-applying member (metallic plates 14, 15 or current-carrying rail 12), proper insulation of these members may be maintained even when the interior of the treating container 10 becomes an unfavorable environment for electric insulation such as a high-humidity environment with a high moisture content.

Moreover, in the power applying apparatus 100 of the present embodiment, the metallic plate 15 is supported on the tip end face of the insulators 20b provided upright on the lower wall 10e of the treating container 10, so that a dead space is eliminated from the treating space 10a and effective utilization of the treating space 10a is made.

It should be noted that although, as an example of use of the power applying apparatus 100, the case has hereinabove been described where it is used as a thawer of frozen materials 21, its uses are not limited thereto. The power applying apparatus 100, conversely to thawing, is also usable in the application as a freezer that freezes foodstuffs or drinking water at a predetermined temperature (e.g. not lower than −60° C. and not higher than 0° C.), and is also usable in the application as a freshness preserver for preserving freshness of frozen materials 21 at the above predetermined temperature range (e.g. not lower than −5° C. and not higher than 10° C.) without causing their freezing.

Moreover, the power applying apparatus 100 is further usable as an oxidation suppressing apparatus that suppress oxidation of various materials such as metallic materials (e.g. heating oxidation of metallic materials) as well as oxidation of foodstuffs and drinking water.

### EXAMPLE 1

The results of verification of the effect of preserving freshness of perishable foodstuffs showed by the power applying apparatus 100 of the above embodiment will be described.

In Example 1, the usage example of the power applying apparatus 100 as a freshness preserver that keeps freshness of perishable foodstuffs will be discussed. The same discussion, however, is also applicable to the case in which the power applying apparatus 100 is used as a freezer or a thawer.

This verification was conducted by a method in which the perishable foodstuffs listed below were placed on metallic plate 14 inside the treating container 10 which is internally set at a predetermined temperature (here, −1° C.), the perishable foodstuffs were given predetermined currents (here, four patterns of 100 μA, 500 μA, 800 μA, and 1 mA) and stored for one week, and the degrees of freshness of the perishable foodstuffs (evaluation items: dripping (release of water), color and smell) were visually checked.

As a comparative example, the same foodstuffs were placed in an existing refrigerator (with no current applied: 0 μA), and the perishable foodstuffs were stored for one week, with the temperature set at the same temperature as inside the above treating container 10. The verification results are summarized in the following table.

TABLE 1
Various freshness preservation tests verification table (minus 1° C.)

| foodstuff | state | 0 μA | 100 μA | 500 μA | 800 μA | 1 mA |
|---|---|---|---|---|---|---|
| pork ham | dripping | somewhat large | small amount | very small amount | very small amount | somewhat large |
| | | amount (from 2^{nd} day) | | | | amount (from 5th day) |
| | color | slowly discolored | somewhat discolored | good | good | somewhat discolored |
| | | (fat from | | | | |
| | | white to yellow) | | | | |
| | smell | not present | not present | not present | not present | not present |
| | evaluation | Bad | somewhat bad | good | good | somewhat bad |
| chicken | dripping | large amount | small amount | very small amount | very small amount | small amount |
| | color | generally discolored | centrally discolored | good | good | generally somewhat |
| | | | | | | discolored |
| | smell | not present | not present | not present | not present | not present |
| | evaluation | Bad | somewhat bad | good | good | somewhat bad |
| shrimp | dripping | large amount | large amount | very small amount | very small amount | small amount |
| | | (from 3rd day) | (from 4th day) | | | (from 5th day) |
| | color | discolored dark | colored dark | good | good | discolored dark |
| | smell | Present | present | somewhat present | somewhat present | present |
| | evaluation | very bad | bad | good | good | bad |
| scallop | dripping | large amount | small amount | very small amount | very small amount | small amount |
| | | (from 3rd day) | (from 3rd day) | (from 6th day) | (from 6th day) | (from 5th day) |
| | color | generally discolored | somewhat discolored | good | good | generally somewhat |
| | | | | | | discolored |
| | smell | Present | not present | not present | not present | present |
| | evaluation | Bad | somewhat bad | good | good | somewhat bad |
| strawberry | dripping | small amount | not present | very small amount | very small amount | small amount |
| | color | somewhat discolored | good | somewhat | somewhat | somewhat discolored |
| | | | | discolored | discolored | |
| | smell | not present | not present | not present | not present | not present |
| | evaluation | Bad | good | somewhat bad | somewhat bad | bad (spoil from |
| | | | | (spoil from 3rd day) | (spoil from 3rd day) | 6th day) |
| lettuce | dripping | not present | not present | not present | not present | not present |
| | color | discolored from root | good | discolored from root | discolored from root | discolored from root |
| | smell | not present | not present | not present | not present | not present |
| | evaluation | somewhat bad | good | bad | bad | bad |

(1) Pork Ham

It was found that if the current output value of the power applying apparatus 100 was set within a suitable current range which is not smaller than 500 μA and not larger than 800 μA, the pork ham inside the treating container 10 produced a very small amount of drippings, kept its color well, and emitted no smell, thereby properly preserving the freshness. On the other hand, it was ascertained that the pork ham in the refrigerator (comparative example: with no current applied) produced a somewhat increased amount of drippings (from the second day) and developed gradual discoloration.

Furthermore, it was found that if the current output value of the power applying apparatus 100 was set lower than the above suitable range (100 μA), the pork ham in the treating container 10 produced a small amount of drippings and somewhat developed discoloration, and it was found that if the current output value of the power applying apparatus 100 was set higher than the above suitable current range (1 mA), the pork ham in the treating container 10 produced a somewhat increased amount of drippings and somewhat developed discoloration.

(2) Chicken Meat

It was found that if the current output value of the power applying apparatus 100 was set within a suitable current range which is not smaller than 500 μA and not larger than 800 μA, the chicken meat inside the treating container 10 produced a very small amount of drippings, kept its color well, and emitted no smell, thereby properly preserving the freshness. On the other hand, it was ascertained that the chicken meat in the refrigerator (comparative example: with no current applied) produced a large amount of drippings and developed discoloration as a whole.

Furthermore, it was found that if the current output value of the power applying apparatus 100 was set lower than the above suitable range (100 μA), the chicken meat in the treating container 10 produced a small amount of drippings and developed discoloration at a central portion thereof, and it was found that if the current output value of the power applying apparatus 100 was set higher than the above suitable range (1 mA), the chicken meat in the treating container 10 produced a small amount of drippings and somewhat developed discoloration as a whole.

(3) Shrimp

It was found that if the current output value of the power applying apparatus 100 was set within a suitable current range which is not smaller than 500 μA and not larger than 800 μA, the shrimp inside the treating container 10 produced a very small amount of drippings and kept its color well, thereby properly preserving the freshness although it somewhat emitted smell. On the other hand, it was ascertained that the shrimp in the refrigerator (comparative example: with no current applied) produced a large amount of drippings (from the third day), developed dark discoloration, and emitted smell.

Furthermore, it was found that if the current output value of the power applying apparatus 100 was set lower than the above suitable range (100 μA), the shrimp in the treating container 10 produced a large amount of drippings (from the fourth day), developed dark discoloration, and emitted smell, and it was found that if the current output value of the power applying apparatus 100 was set higher than the above suitable range (1 mA), the shrimp in the treating container 10 produced a small amount of drippings (from the fifth day), developed dark discoloration, and emitted smell.

(4) Scallop

It was found that if the current output value of the power applying apparatus 100 was set within a suitable current range which is not smaller than 500 μA and not larger than 800 μA, the scallop inside the treating container 10 produced a very small amount of drippings (from the sixth day), kept its color well, and emitted no smell, thereby properly preserving the freshness. On the other hand, it was ascertained that the scallop in the refrigerator (comparative example: with no current applied) produced a large amount of drippings (from the third day), developed discoloration as a whole, and emitted smell.

Furthermore, it was found that if the current output value of the power applying apparatus 100 was set lower than the above suitable range (100 μA), the scallop in the treating container 10 produced a small amount of drippings (from the third day) and somewhat developed discoloration, and that if the current output value of the power applying apparatus 100 was set higher than the above suitable range (1 mA), the scallop in the treating container 10 produced a small amount of drippings (from the fifth day), somewhat developed discoloration as a whole, and emitted smell.

(5) Strawberry

It was found that if the current output value of the power applying apparatus 100 was set at a suitable weak current of about 100 mA, the strawberry inside the treating container 10 produced no drippings, kept its color well, and emitted no smell, thereby properly preserving the freshness. On the other hand, it was ascertained that the strawberry in the refrigerator (comparative example: with no current applied) produced a small amount of drippings and somewhat developed dark discoloration.

Furthermore, it was found that if the current output value of the power applying apparatus 100 was set to 500 μA or 800 μA, a higher value than the above suitable current value, the strawberry in the treating container 10 produced a very small amount of drippings and somewhat developed discoloration, and it was found that if the current output value of the power applying apparatus 100 was set to 1 mA, a further higher value than the above suitable current value, the strawberry in the treating container 10 produced a small amount of drippings and somewhat developed discoloration.

(6) Lettuce

It was found that if the current output value of the power applying apparatus 100 was set at a suitable weak current of about 100 μA, the lettuce inside the treating container 10 produced no drippings, kept its color well, and emitted no smell, thereby properly preserving the freshness. On the other hand, it was ascertained that the lettuce in the refrigerator (comparative example: with no current applied) developed discoloration from the base thereof.

Furthermore, it was found that if the current output value of the power applying apparatus 100 was set to 500 μA, 800 μA or 1 mA, a higher value than the above suitable current value, the lettuce in the treating container 10 developed discoloration from its base.

Judging comprehensively from all the verification results exemplified above, it is conceivable that, from the viewpoint of the preservation of freshness of perishable foodstuffs by the power applying apparatus 100, an optimum current output value of the power applying apparatus 100 for the foodstuff of meat and seafood lies within a weak current range which is not smaller than 500 μA and not larger than 800 μA.

In addition, with respect to the foodstuff of vegetable and fruit, an optimum current output value of the power applying apparatus 100 is expected to lie at least in a range of further weaker currents than and falling outside the above optimum current range for the foodstuff of meat, etc. (i.e., in the current range which is no smaller than 1 μA and smaller than 500 μA), and more particularly, this current is conceivable to be a current in the vicinity of substantially 100 μA.

It should be noted that although in the present experiments the “current” was used to identify a suitable output value of the power applying apparatus 100, it is also possible to use the “voltage” outputted from the power applying apparatus 100 to identify such suitable range.

Nonetheless, the reason for selecting herein the outputted “current” from the power applying apparatus 100 as an indicator of the suitable range is as follows.

It is estimated that, as mentioned above, the state of electric charge of a perishable foodstuff is deeply related to the activation of tissue of the foodstuff that is indispensable to preserving freshness of the foodstuff. Therefore, the use of “current” to identify a suitable range of output values of the power applying apparatus 100 is presumed more preferable, as it allows direct understanding of the electrically charged state of a foodstuff.

### EXAMPLE 2

The results of verification of the effect of suppressing the freezer burn (oxidation) of frozen tuna and frozen salmon for sushi ingredient use (hereinafter abbreviated as “frozen tuna, etc.”), which effect is performed by the power applying apparatus 100 of the above embodiment, will be described. It should be noted that the suppressing of freezer burn (oxidation) of frozen tuna, etc. is concretely discussed here, but such oxidation also occurs in other frozen foodstuffs (e.g., avocado). Accordingly, the oxidation prevention technique as described below also functions effectively on these foodstuffs.

There is a problem associated with the frozen tuna, etc. for sushi ingredient use, which is referred to as freezer burn. Specifically, it is known that, when the frozen tuna, etc. that have been stably stored in a particular freezer at an extremely low temperature (around −60° C. to −35° C.) are stored in a household freezer or a freezer stocker for distribution use under a normal freezing environment of the order of −20° C., the frozen tuna, etc. sooner or later undergo oxidative discoloration called freezer burn.

Such oxidative discoloration of frozen tuna, etc. lowers their commercial value as an ingredient for sushi, and needs to preferably be reduced to a minimum. On the other hand, it is practically nearly impossible to always keep the frozen tuna, etc. at an extremely low temperature (around −60° C. to −35° C.) in each household or in various networks of domestic distribution.

Thus, the present inventor has developed a technique which makes it possible to prevent the freezer burn of frozen tuna, etc. under a normal freezing environment (around −20° C.).

As a result of various studies, it has been found that if frozen tuna, etc. are subjected to the following steps and then stored under a normal freezing environment (around −20° C.), freezer burn of the frozen tuna, etc. can be prevented. That is, it has been ascertained by a visual experiment that with the frozen tuna, etc. thawed and refrozen after passing through the steps, an improvement is made in the phenomenon of freezer burn of frozen tuna, etc. as compared with the case where frozen tuna, etc. are exposed to the normal freezing environment (−20° C.) directly from storage at an extremely low temperature (in the vicinity of −60° C. to −35° C.).

First, the frozen tuna, etc. having been stored at an extremely low temperature (in the vicinity of −60° C. to −35° C.) are thawed using the above power applying apparatus 100. In this instance, the thawing conditions of the frozen tuna, etc. may be set the same as mentioned in the above embodiment. In other words, the temperature of the treating space 10 of the power applying apparatus 100 may be set to a value which is not lower than −5° C. and not higher than +10° C. The load voltage of the power applying apparatus 100 may be set to a value which is not smaller than 10V and not larger than 5 kV. In addition, the load current of the power applying apparatus 100 may be set to a value which is not smaller than 1 μA and not larger than 1,000 mA.

Next, part of the frozen tuna, etc. is cut off for sushi ingredient use, and the frozen tuna, etc. are refrozen with cold air at about −50° C. using a suitable quick static freezer. Also in this instance, it is preferable to provide the same load voltage and load current as mentioned above to the frozen tuna, etc. Nonetheless, it is conceivable that the above-mentioned application of power to the frozen tuna, etc. at the time of their thawing is important for the suppressing action of freezer burn of the frozen tuna, etc.

Thereafter, the frozen tuna, etc. are stored under a normal freezing environment (−20° C.).

From the foregoing description, various improvements and other embodiments of the present invention will be apparent to a person skilled in the art. Accordingly, the above description should be construed as examples only, it being provided for the purpose of giving the skilled person the best mode for carrying out the invention. A substantial change can be made in the particulars of the structure and/or function of the present invention without departing from its spirit. For example, the load current of the power applying apparatus 100 is set to a value which is not smaller than 1 μA and not larger than 1,000 mA in the present embodiment. However, taking into account the capacity of an actual machine (power applying apparatus), it may be preferable to set to a value which is not smaller than 1 μA and not larger than several tens of mA.

### INDUSTRIAL APPLICABILITY

The treating apparatus of the present invention enables to properly prevent deterioration in quality of an object to be treated and is utilizable, for example, as a commercial-use or home-use thawer for frozen materials capable of properly preserving the freshness of frozen materials at the time of their thawing.

1. A treating apparatus comprising:
a container having an interior set at a predetermined temperature;
a support means for supporting an object to be treated in the container such that insulation is maintained between the container and the object to be treated; and
an alternating-current power applying means for applying an alternating-current voltage which is not smaller than 10V and not larger than 5 kV, through the support means, to the object to be treated such that a current which is not smaller than 1 μA and not larger than 1,000 mA flows therein,
wherein oxidation of the object to be treated is suppressed by providing the current to the object to be treated.

2. A treating apparatus comprising:
a container having an interior set at a predetermined temperature;
a support means for supporting a frozen object to be treated in the container such that insulation is maintained between the container and the object to be treated; and
an alternating-current power applying means for applying an alternating-current voltage which is not smaller than 10V and not larger than 5 kV, through the support means, to the object to be treated such that a current which is not smaller than 1 μA and not larger than 1,000 mA flows therein,
wherein the object to be treated is thawed by providing the current to the object to be treated.

3. A treating apparatus comprising:
a container having an interior set at a predetermined temperature;
a support means for supporting an object to be treated in the container such that insulation is maintained between the container and the object to be treated; and
an alternating-current power applying means for applying an alternating-current voltage which is not smaller than 10V and not larger than 5 kV, through the support means, to the object to be treated such that a current which is not smaller than 1 μA and not larger than 1,000 mA flows therein,
wherein freshness of the object to be treated is preserved without its freezing by providing the current to the object to be treated.

4. The treating apparatus according to claim 1, wherein the support means comprises:
a first metallic plate disposed in the interior to place the object to be treated thereon;
a current-carrying rail of metal electrically connected to the first metallic plate; and
a metallic support bar for supporting the first metallic plate through a first insulating member,
wherein the alternating-current voltage is applied to the current-carrying rail.

5. The treating apparatus according to claim 4, wherein the support means comprises:
a second insulating member extending upright from a lower wall of the container into the interior;
a second metallic plate supported on an end face of the second insulating member to place the object to be treated thereon,
wherein the second metallic plate is electrically connected to the current-carrying rail through a wire.

6. The treating apparatus according to claim 4, wherein the support means comprises a hook for supporting the first insulating member and the first metallic plate,
wherein a position of the first metallic plate is set based on a locking position of the hook to the metallic support bar.

7. The treating apparatus according to claim 5, wherein the first and second insulating member are insulators.

8. The treating apparatus according to claim 1, wherein the current is set to a value which is not smaller than 500 μA and not larger than 800 μA if the object to be treated is a foodstuff of meat or seafood.

9. The treating apparatus according to claim 1, wherein the current is set to a value which is not smaller than 1 μA and smaller than 500 μA if the object to be treated is a foodstuff of vegetable or fruit.

10. The treating apparatus according to claim 9, wherein the current is substantially 100 μA.

11. The treating apparatus according to claim 2, wherein frozen tuna or frozen salmon is thawed as the object to be treated.

12. The treating apparatus according to claim 2, wherein the support means comprises:
a first metallic plate disposed in the interior to place the object to be treated thereon;
a current-carrying rail of metal electrically connected to the first metallic plate; and
a metallic support bar for supporting the first metallic plate through a first insulating member,
wherein the alternating-current voltage is applied to the current-carrying rail.

13. The treating apparatus according to claim 3, wherein the support means comprises:
a first metallic plate disposed in the interior to place the object to be treated thereon;
a current-carrying rail of metal electrically connected to the first metallic plate; and
a metallic support bar for supporting the first metallic plate through a first insulating member,
wherein the alternating-current voltage is applied to the current-carrying rail.
